(19) United States
(12) Patent Application Publication
(10) Pub. No.: US 2005/0242696 A1
(43) Pub. Date: Nov. 3, 2005

(54) Plasma display panel and method of fabricating the same

(76) Inventor: Jung-Suk Song, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/120,048

(22) Filed: May 2, 2005

(30) Foreign Application Priority Data
May 3, 2004 (KR) 10-2004-0030990

(51) Int. Cl. H01J 17/49

(52) U.S. Cl. 313/292; 313/582

(57) ABSTRACT

Provided are a plasma display panel and a method of fabricating the same. The method includes preparing a transparent substrate; applying a raw material for forming barrier ribs on the substrate; applying a photoresist on the raw material for forming barrier ribs; exposing and developing the photoresist to form first barrier ribs disposed in a first direction on the substrate and second barrier ribs disposed in a second direction to define discharge spaces; injecting an etchant through openings of the photoresist to etch the raw material so that heights of the first and second barrier ribs are different from each other, and to form a gas exhaustion path for exhausting impure gas during a vacuum exhaustion process; and removing the photoresist remaining on the raw material to complete the barrier ribs including the first and second barrier ribs.

### CROSS-REFERENCE TO RELATED PATENT APPLICATIONS

This application claims the benefit of Korean Patent Application No. 10-2004-0030990, filed on May 3, 2004, in the Korean Intellectual Property Office, the disclosure of which is incorporated herein in its entirety by reference.

### BACKGROUND OF THE INVENTION

1. Field of the Invention

The present invention relates to a plasma display panel, and more particularly, to a plasma display panel having barrier ribs, wherein the varying heights of the ribs form an air exhaustion path, and a method of fabricating the plasma display panel.

2. Description of the Related Art

In general, a plasma display panel is a flat panel display device displaying images. In the manufacture of a plasma display panel, discharge electrodes are formed on facing surfaces of a plurality of substrates and a discharge gas is injected between the plurality of substrates. During operation, predetermined voltages are applied to the discharge electrodes to generate ultraviolet radiation in a discharge space, and this radiation excites phosphor material in a phosphor layer. Thus, the image is displayed using visible light generated by the excited phosphor layer.

A conventional plasma display panel includes the following components: (1) a front substrate, (2) a rear substrate facing the front substrate, (3) pairs of sustain discharge electrodes disposed on an inner surface of the front substrate, (4) a front dielectric layer covering the sustain discharge electrode pairs, (5) a protective layer coated on the front dielectric layer, (6) address electrodes disposed on an inner surface of the rear substrate, (7) a rear dielectric layer covering the address electrodes, (8) barrier ribs disposed between the front substrate and the rear substrate, and (9) red, green, and blue phosphor layers coated in the barrier ribs.

Here, in order to fabricate the barrier ribs, the rear substrate is cleaned, a raw material for the barrier ribs is applied on the upper surface of the rear substrate, the applied raw material is dried, a photolithographic mask is aligned to expose and develop the barrier ribs, the raw material on the portion where the barrier ribs will not be formed is removed in a sand blast process, the remaining photoresist is separated, and the barrier ribs are baked in an oven.

In the conventional barrier ribs fabrication process, an abrasive agent such as CaCO₃ is injected onto the substrate with high pressure. Fine scratches may be formed on the rear substrate during this sand blasting process.

Recently, an etching process has been used wherein the raw material for barrier ribs is first applied on the substrate, a photoresist film is applied thereon and exposed and developed, and an etchant is then injected onto the portion where discharge spaces will be formed, thus etching away the spaces between the barrier ribs.

As examples, Korean Laid-open Patent No. 2000-13228 discloses barrier ribs having heights larger than their widths which are manufactured by etching after forming recesses on the substrate, and Korean Laid-open Patent No, 1993-8917 discloses a method of forming barrier ribs by directly etching the substrate.

However, referring to FIG. 1, the conventional barrier rib 180 formed by the known etching process has a profile that is hollowed out on both sides. Accordingly, the width (W1) of an upper end portion 181 of the barrier rib 180 is much larger than the width (W2) of a center portion 182 of the barrier rib 180.

For example, where the width of the upper end portion 181 of the barrier rib 180 is 40 μm, the width of the center portion 182 of the barrier rib 180 is reduced to about 20 μm via etching. Therefore, when phosphor layers emit light, a light emitting path may be interrupted by the barrier rib, and the light emitting efficiency is lowered due to a reduced discharge capacity.

In addition, a conventional plasma display panel includes a protective layer having a strong humidity-absorption characteristic and a large quantity of impure gas in the porous phosphor layer. The impure gas remaining in the panel assembly negatively affects the life span characteristic of the panel because it can cause the formation of a permanent residual image and an unstable discharge.

Therefore, during manufacture, a large quantity of impure gas is discharged out of the panel by a vacuum exhaustion process. However, in a conventional plasma display panel having no space between the substrate and the top of the barrier rib, it is difficult to exhaust the impure gas completely.

### SUMMARY OF CERTAIN INVENTIVE EMBODIMENTS

The present invention provides a plasma display panel with a path through which gas can be exhausted in a vacuum exhaustion process, wherein the path is provided by barrier ribs having different heights from each other, and a method of fabricating the plasma display panel.

Embodiments of the invention also provide a plasma display panel comprising barrier ribs having different heights from each other formed by controlling widths and heights of the barrier rib in an etching process, and a method of fabricating the plasma display panel.

According to an aspect of the invention, a method of fabricating a plasma display panel comprises applying a raw material for forming barrier ribs on a substrate; applying a photoresist on the raw material for forming barrier ribs; exposing and developing the photoresist to form first barrier ribs disposed in a first direction on the substrate and second barrier ribs disposed in a second direction, thereby defining discharge spaces; etching the raw material through openings of the photoresist so that heights of the first and second barrier ribs are different from each other, and to form a gas exhaustion path for exhausting impure gas during a vacuum exhaustion process; and removing the photoresist remaining on the raw material to complete the barrier ribs.

During formation of the barrier rib pattern, the second barrier ribs may respectively connect pairs of adjacent first barrier ribs in alternate pairs to define discharge cells, in order to provide another gas exhaustion path between the first barrier ribs that are not connected to each other.

A distance between the first barrier ribs that define a non-discharge region may be narrower than a distance between the pair of first barrier ribs that define the discharge cell.

According to another aspect of the invention, a plasma display panel comprises a front substrate; a plurality of pairs of sustain discharge electrodes formed on an inner surface of the front substrate; a front dielectric layer covering the sustain discharge electrode pairs; a rear substrate facing the front substrate; a plurality of address electrodes formed on an inner surface of the rear substrate and disposed in a direction crossing the sustain discharge electrode pairs; a rear dielectric layer covering the address electrodes; a plurality of barrier ribs including first barrier ribs disposed between the front and rear substrates and arranged in a first direction of the substrates, and second barrier ribs extending from the first barrier ribs in a second, different direction to define discharge cells, wherein the first and second barrier ribs have different heights so as to provide a gas exhaustion path for exhausting impure gas during a vacuum exhaustion process; and red, green, and blue phosphor layers applied in the discharge cells.

The height of the first barrier ribs may be relatively lower than that of the second barrier ribs, and the gas exhaustion path corresponding to the height difference between the first and second barrier ribs may be formed above the first barrier ribs.

The first barrier ribs may be arranged in a direction crossing the address electrodes, the second barrier ribs may be arranged in parallel to the address electrodes, and the second barrier ribs may extend from the inner sides of the adjacent first barrier ribs toward the facing first barrier ribs to define the discharge cells.

The method may further comprise forming a non-discharge region providing an additional gas exhaustion path for exhausting the impure gas, wherein the non-discharge region is formed between predetermined adjacent first barrier ribs.

In some embodiments, a distance between the first barrier ribs that define the non-discharge region may be narrower than a distance between adjacent first barrier ribs that define the discharge cell.

### BRIEF DESCRIPTION OF THE DRAWINGS

The above and other features and advantages of the present invention will become more apparent by describing in detail exemplary embodiments thereof with reference to the attached drawings in which:

FIG. 1 is a cross-sectional view of conventional barrier ribs;

FIG. 2 is an exploded perspective view of a portion of a plasma display panel according to one embodiment of the invention;

FIG. 3 is a cross-sectional view of the plasma display panel in an assembled status;

FIGS. 4A through 4I cross-sectional views of processes fabricating the barrier ribs of FIG. 2;

FIG. 4A is a cross-sectional view of a partially fabricated plasma display panel where address electrodes and a dielectric layer are formed on a substrate;

FIG. 4B is a cross-sectional view of a partially fabricated plasma display panel where a raw material for barrier ribs is applied on the substrate of FIG. 4A;

FIG. 4C is a cross-sectional view of a partially fabricated plasma display panel where a photoresist is applied on the substrate of FIG. 4B;

FIG. 4D is a cross-sectional view of a partially fabricated plasma display panel where the photoresist is exposed and developed on the substrate of FIG. 4C;

FIG. 4E is a cross-sectional view of etching the substrate of FIG. 4D;

FIG. 4F is a cross-sectional view of etching the substrate of FIG. 4E;

FIG. 4G is a cross-sectional view of etching the substrate of FIG. 4F;

FIG. 4H is a cross-sectional view of the substrate of FIG. 4G, on which the etching process is completed;

FIG. 4I is a cross-sectional view of the substrate of FIG. 4G taken along a line perpendicular to the cross-section of FIG. 4G, on which the etching process is completed;

FIG. 4J is an enlarged cross-sectional view of a portion of the substrate in FIG. 4H; and

FIG. 5 is an exploded perspective view of a portion of a plasma display panel according to another embodiment of the invention.

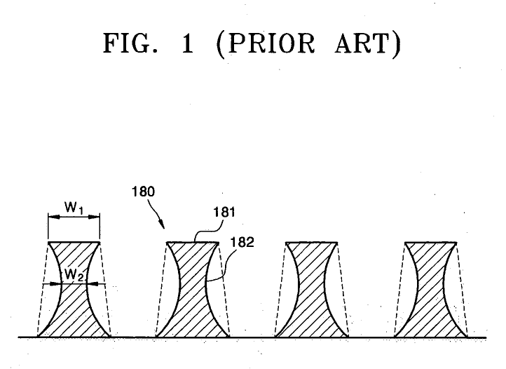

### DETAILED DESCRIPTION OF CERTAIN EMBODIMENTS OF THE INVENTION

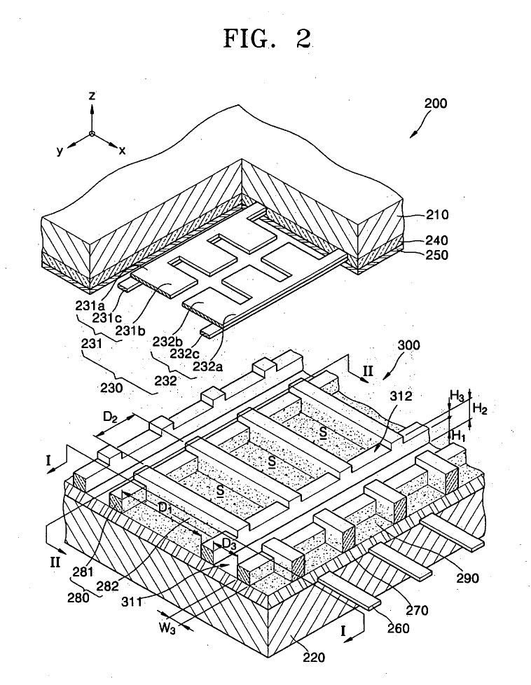

FIG. 2 is an exploded view of a plasma display panel 200 according to one embodiment of the invention.

Referring to FIG. 2, the plasma display panel 200 includes a front substrate 210, and a rear substrate 220 facing the front substrate 210.

Pairs of sustain discharge electrodes 230 are disposed on an inner surface of the front substrate 210. Each pair of sustain electrodes 230 includes an X electrode 231 and a Y electrode 232. The X electrode 231 includes a first transparent electrode line 231a having a substantially strip shape, a first protrusion 231b from the first transparent electrode line 231a toward the Y electrode 232, and a first bus electrode line 231c formed along an edge of the first transparent electrode line 231a. The Y electrode 232 includes a second transparent electrode line 232a of a substantially strip shape, a second protrusion 232b from the second transparent electrode line 232a toward the X electrode 231, and a second bus electrode line 232c formed along an edge of the second transparent electrode line 232a.

In one embodiment, the first transparent electrode line 231a, the first protrusion 231b, the second transparent electrode line 232a, and the second protrusion 232b are formed of a transparent conductive material, for example, an indium tin oxide (ITO) film. In addition, the first bus electrode line 231c and the second bus electrode line 232c are preferably formed of a highly conductive material, such as Ag paste, in order to reduce electric resistance of the first and second transparent electrode lines 231a and 232a.

The plasma display panel 200 further comprises a front dielectric layer 240 formed on the front substrate 210 in order to cover the X and Y electrodes 231 and 232, and a protective layer 250, such as an MgO layer, is deposited on the front dielectric layer 240.

Address electrodes 260 are formed on an inner surface of the rear substrate 220, wherein the address electrodes 260 are disposed so as to cross the sustain electrode pairs 230. A rear dielectric layer 270 is formed on the address electrodes 260 in order to cover the address electrodes 260. Barrier ribs 280 are formed on the rear dielectric layer 270 in order to define discharge cells and prevent generation of cross talk between adjacent discharge cells. An upper surface of the rear dielectric layer 270 and inner side surfaces of the barrier ribs 280 of each discharge cell are coated with a red, green, or blue phosphor layer 290.

The plasma display panel 200 further comprises gas exhaustion paths through which impure gas can be exhausted in a vacuum exhaustion process. The gas exhaustion paths are formed between the barrier ribs, wherein the barrier ribs are formed by an etching process to have different heights from each other to thereby provide an additional gas exhaustion path.

The gas exhaustion paths will be described in more detail as follows.

As discussed above, the barrier ribs 280 are formed on the rear substrate 220. The barrier ribs 280 include first barrier ribs 281 disposed in a first direction crossing the address electrodes 260 (Y direction), and second barrier ribs 282 disposed in parallel to the address electrodes 260 (X direction).

The first barrier ribs 281 are disposed in the Y direction of the rear substrate 220 in a strip pattern, and the second barrier ribs 282 extend from the inner walls of the adjacent pair of first barrier ribs 281 toward each other to define the unit discharge cell as illustrated in FIG. 2.

Specifically, the second barrier rib 282 connects two adjacent first barrier ribs 281 to define the discharge cell. However, the second barrier ribs 282 connect the first barrier ribs 281 in alternate pairs to form first gas exhaustion paths 311 between the first barrier ribs 281, which are not connected by the second barrier rib 282. The first gas exhaustion path 311 is a non-discharge region.

The first and second barrier ribs 281 and 282 are coupled integrally to each other, and the discharge cell defined by the barrier ribs 281, 282 has a substantially rectangular shape. Alternately, the barrier ribs 280 can be formed in various shapes such as a waffle type, a meander type, or a delta type, and the discharge space can be formed as a circle, a triangle, or a hexagon.

The discharge spaces (S) are continuously formed in a direction crossing the address electrodes 260 (Y direction), and the barrier ribs 280 are formed in a ladder structure along the Y direction of the panel 200. The ladder assemblies are disposed along the X direction of the panel 200 and are separated from each other at predetermined intervals.

In the plasma display panel 200, the first gas exhaustion path 311 is formed in the same direction as the first barrier ribs 281. However, the direction of a gas exhaustion path is not limited to one direction if it can form a path exhausting the impure gas.

In the plasma display panel 200, the first barrier ribs 281 disposed in a first direction are stepped from, or reduced in height as compared to, the second barrier ribs 282 disposed in a second, different direction. The differing heights of the first and second barrier ribs 281, 282 form second gas exhaustion paths 312.

In the embodiment illustrated in FIG. 2, a height (H1) of the first barrier rib 281 is lower than a height (H2) of the second barrier rib 282. More specifically, the height H1 of the first barrier rib 281, disposed at both ends of the second barrier ribs 282 to connect the two adjacent second barrier ribs 282, is lower than the height H2 of the second barrier rib 282 by as much as a distance H3.

Accordingly, when the barrier ribs 280 are coupled to the front substrate 210, the second gas exhaustion paths 312 are formed between the lower surface of the front substrate 210 and the tops of the barrier ribs 280 due to the height difference H3. In some embodiments, the second gas exhaustion path 312 is formed at every first barrier rib 281 connecting the second barrier ribs 282, or the second gas exhaustion path can be selectively formed at a portion of the first barrier rib 281.

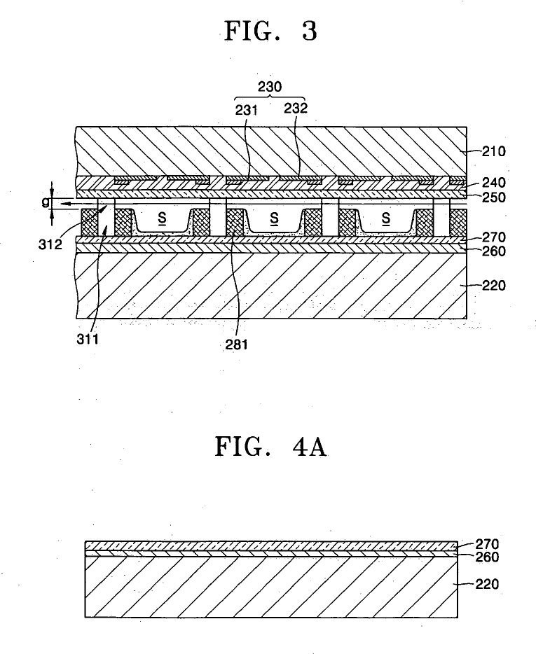

FIG. 3 is a cross-sectional view of the front substrate 210 and the rear substrate 220 of FIG. 2 coupled to each other taken along line I-I.

Here, the same reference numerals denote the same elements performing the same functions as those of the previous drawings.

Referring to FIG. 3, the first barrier ribs 281 are disposed between the front substrate 210 and the rear substrate 220, wherein the height difference H3 between the heights of the first barrier rib 281 and the second barrier rib 282 (refer to FIG. 2) form a gap (g).

The gap (g) is formed between the front substrate 210 and the top of the first barrier rib 281, wherein the gap (g) forms the second gas exhaustion path 312. The second gas exhaustion path 312 provides a path denoted by arrow 312, through which the gas can be exhausted, in a vacuum exhaustion process.

As discussed above and also illustrated in FIG. 3, the first gas exhaustion path 311 is formed on the non-discharge region between the pair of adjacent first barrier ribs 281 defining the discharge cell (S). The first gas exhaustion path 311 is in communication with the second gas exhaustion path 312.

In some embodiments, height difference between the first barrier rib 281 and the second barrier rib 282 is formed by an etching process.

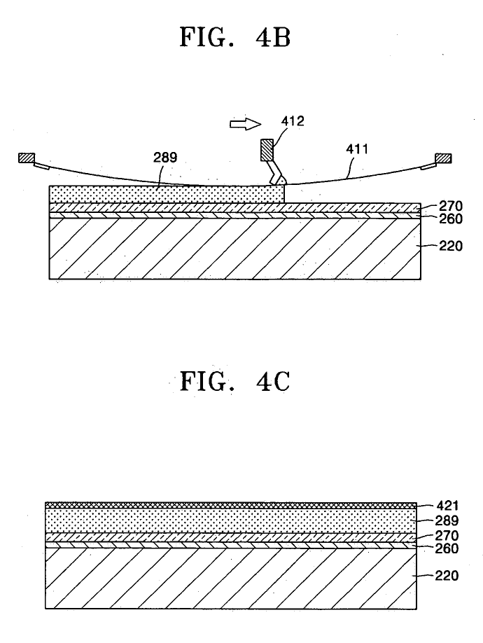

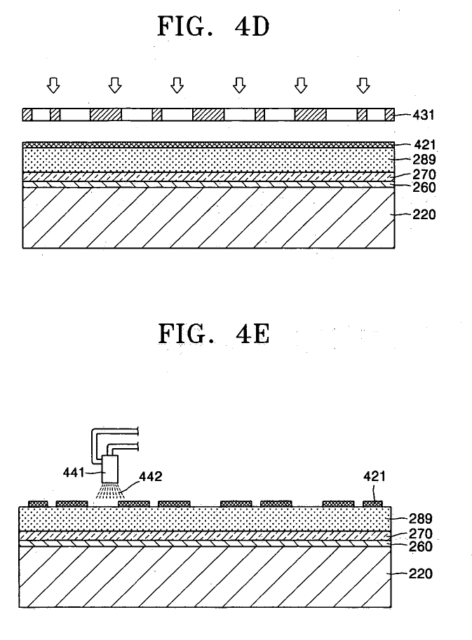

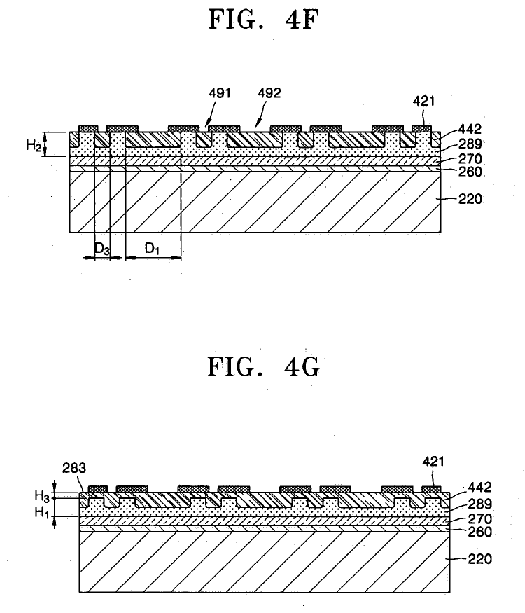

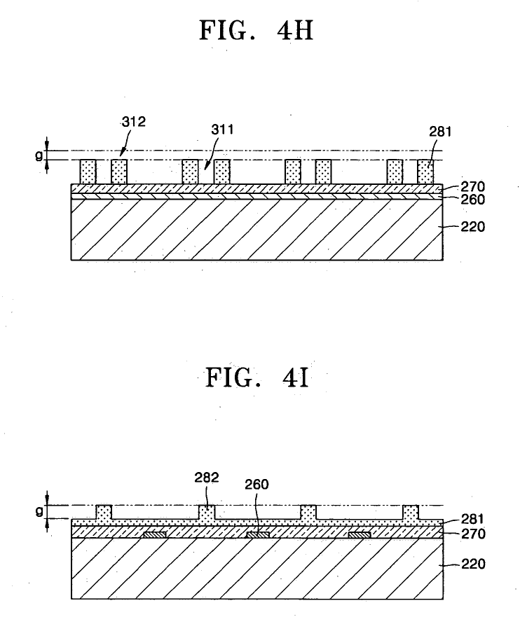

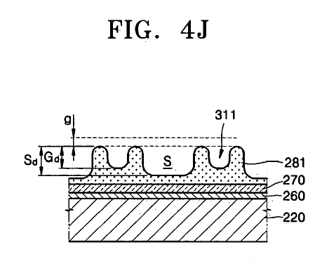

Embodiments of a method of fabricating a plasma display panel with barrier ribs 280 will be described in detail with reference to FIGS. 4A through 4I.

Referring to FIG. 4A, the rear substrate 220 formed of a transparent glass is prepared. Preparation of the substrate 220 comprises printing the address electrode 260 on the rear substrate 220 and baking the printed substrate. The address electrode 260 is preferably formed in a strip pattern along a direction (Y direction) of the rear substrate 220. Preparing the rear substrate further comprises coating the rear dielectric layer 270 on the rear substrate 220 to cover the address electrode 260.

Referring to FIG. 4B, a raw material 289 for forming barrier ribs is printed on the rear substrate 220. The raw material 289 may be applied to the entire substrate 220 or a portion thereof, and may be applied in various ways. In one embodiment, the raw material 289 is loaded on a screen 411, and a squeeze 412 proceeds forward on the screen to apply the raw material 289 on the entire substrate 220.

Referring to FIG. 4C, a photoresist 421 is applied on an upper surface of the raw material 289. In one embodiment, the photoresist 421 is applied over the entirety of the raw material 289.

Referring to FIG. 4D, a photolithographic mask 431 is aligned over the photoresist 421 at a predetermined distance from the photoresist 421 as shown in FIG. 4D. As also illustrated in FIG. 4D, the photolithographic mask 431 and the photoresist 421 are radiated with ultraviolet light to perform exposure and development processes.

In response to the ultraviolet light exposure, the photoresist 421 remains on the surface of the raw material 289 at locations corresponding to the barrier ribs that will be formed, and the photoresist 421 on the other portions is removed, as shown in FIG. 4E.

Following formation of the pattern of photoresist 421 corresponding to the barrier ribs, an etchant 442 is applied or injected through a nozzle 441 from the upper portion of the photoresist 421 to etch or corrode the patterned raw material 289 for a predetermined time, thereby forming the barrier ribs of the desired shape. In the embodiment illustrated in FIGS. 4A-I, the width of the barrier ribs is larger than the height thereof.

The corrosion of the raw material 289 by the etchant 442 is shown in FIGS. 4F and 4G, wherein FIGS. 4F and 4G are cross-sectional illustrates of the rear substrate 220 taken along line I-I of FIG. 2. Referring to FIG. 4F, the status of the raw material 289 is shown immediately prior to generating the height difference between the first barrier rib 281 and the second barrier rib 282 by injecting the etchant 442 through openings 491 and 492 in the photoresist 421. The etchant 442 starts etching the raw material 289 from the surface where the photoresist 421 is absent, and proceeds from the surface of the raw material 289 with isotropic etching speed in both vertical and horizontal directions. FIG. 4G illustrates the status of the raw material 289 after the height difference has been generated between the first barrier rib 281 and the second barrier rib 282 due to the isotropic etching speed of the etchant 442 in both the horizontal and vertical directions.

Referring back to FIG. 2, an etched distance (D3) where the first gas exhaustion path 311 is formed is narrower than an etched distance (D1) where the discharge cell will be formed. For example, in one embodiment the distance D1 between the pair of adjacent first barrier ribs 281 is about 493 μm and a distance D2 between the pair of adjacent second barrier ribs 282 is about 228 μm, and the distance D3 of the first gas exhaustion path 311 is about 100 μm. That is, the distance D3 of the first gas exhaustion path 311 is relatively narrower than the distance D1 between the first barrier ribs 281 of the discharge cell. In addition, the width of the first barrier rib 281 is the same as the width W3 of the second barrier rib 282 (about 50 μm), and the height H2 of the barrier rib 282 is about 120 μm.

Referring again to FIGS. 4F and 4G, when the etchant 442 is injected through an opening 491 in the photoresist 421, for example, an opening of 50 μm, the etching of the barrier rib 280 is performed wherein the isotropic etching speed is substantially the same in both vertical and horizontal directions.

In one embodiment, the etching distance D3 of the portion where the first gas exhaustion path 311 will be formed is about 100 μm to a left and a right horizontal direction, while the entire height of the barrier rib 282 is etched to be about 120 μm. Accordingly, the etching proceeds further in the horizontal direction of the first barrier rib 281 due to the isotropic etching to form the first barrier ribs 281, thereby forming the first gas exhaustion path 311. Specifically, the etching distance of the portion where the first gas exhaustion path 311 will be formed is shorter than the entire height of the portion where the barrier rib 280 will be formed. Therefore, the height H1 of the first barrier rib 281 is etched lower than the height H2 of the second barrier rib 282 by as much as H3. Reference numeral 283 denotes an upper end line of the second barrier rib 282.

Where the etchant 442 is applied or injected through an opening 492 of the photoresist 421, wherein the opening 492 is located at the discharge space, the height H2 of the formed second barrier rib 282 is higher than the height H1 of the first barrier rib 281 by controlling the width of the opening 492.

As discussed above, the width D3 of the first gas exhaustion path 311 is different from (a) the distance D1 between the first barrier ribs 281 defining the discharge spaces, and (b) the distance D2 between the second barrier ribs 282 defining the discharge spaces. Therefore, the first barrier ribs 281 forming the first gas exhaustion path 311 and having relatively narrower width than the second barrier ribs 282 due to the isotropic etching speed of the etchant 442. Thus, the top of the first barrier rib 281 is etched, and the the heights of the first and second barrier ribs 281 and 282 are different from each other.

Following removal of the remaining photoresist 421, the difference in height between the height H1 of the first barrier ribs 281 disposed on both sides of the first gas exhaustion path 311 and the height H2 of the second barrier rib 282 is illustrated in FIGS. 4H and 4I. According to the difference in height between H1 and H2 of the first and second barrier ribs, the gap (g) is formed between the tops of the first barrier ribs 281 and the tops of the second barrier ribs 282. As discussed above, the gap (g) forms the second gas exhaustion path 312.

FIG. 4J is an enlarged cross-sectional view of a part of the substrate in FIG. 4H. A depth Sd of the discharge cell S is deeper than a depth Gd of the first gas exhaustion path 311 as shown in FIG. 4J. Like in FIG. 4F, since the area of the opening 492 in the photoresist 421 for formation of the discharge cell S is larger than the area of the opening 491 in the photoresist 421 for formation of the first gas exhaustion path 311, the amount of etchant injected through the opening 492 is more than that injected through the opening 491. Thus, the discharge cell S is etched to a greater depth Sd than the depth Gd of the gas exhaustion path 311. When the depth Sd of the discharge cell S is greater than the depth Gd of the first gas exhaustion path 311, the area where the phosphor material is applied to form the phosphor layer 290 (see FIG. 2 and discussion thereof) in the discharge cell S is enlarged.

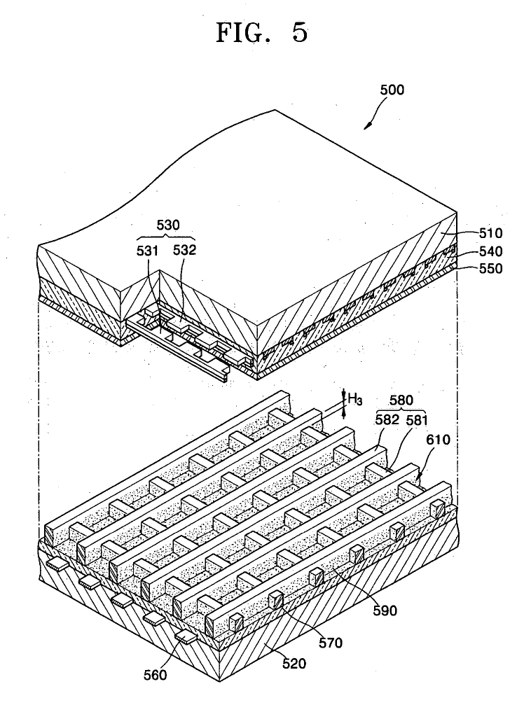

FIG. 5 is a perspective view of another embodiment of a plasma display panel 500.

Referring to FIG. 5, the plasma display panel 500 includes a front substrate 510 and a rear substrate 520. The plasma display panel 500 also comprises pairs of sustain electrodes 530 formed on an inner surface of the front substrate 510, wherein the sustain electrodes 530 include X electrodes 531 and Y electrodes 532 facing the X electrodes 531. The sustain electrode pairs 530 are covered by a front dielectric layer 540, and a protective layer 550 is deposited on the surface of the front dielectric layer 540.

Address electrodes 560 are disposed on the front substrate 520, and the address electrodes 560 are covered by a rear dielectric layer 570. In addition, barrier ribs 580 are formed on the rear dielectric layer 570, and red, green, and blue phosphor layers 590 are coated on inner side surfaces of the barrier ribs 580.

In the plasma display panel 500, the barrier ribs 580 include first barrier ribs 581 disposed in first direction crossing the address electrode 560, and second barrier ribs 582 disposed in a second direction parallel to the address electrodes 560. The first and second barrier ribs 581 and 582 are coupled together to form a lattice configuration.

Gas exhaustion paths 610 are formed above upper end portions of the first barrier ribs 581. In certain embodiments, the gas exhaustion path 610 is formed by the etching or removal of an upper end portion of the first barrier ribs 581. Specifically, the gas exhaustion path 610 may be formed by the isotropic etching speed of the etchant in the unit discharge cell defined by the first barrier rib 581 and the second barrier rib 581, wherein first barrier rib 581 and the second barrier rib 581 defining the discharge cell have different lengths.

According to the plasma display panels and methods of fabricating described above, one or more of the following effects can be obtained.

Because the raw material for forming barrier ribs is etched by the etchant having isotropic etching speed, the barrier rib disposed in one desired direction is formed with a different height than that of the barrier rib disposed in another direction. Accordingly, a predetermined space or gap is be formed above the first barrier ribs, thereby forming the gas exhaustion path through which the gas can be exhausted during the vacuum exhaustion process.

In addition, because the gas exhaustion path is formed between the tops of some barrier ribs and the lower surface of the substrate, impure gas can be exhausted sufficiently from a center portion of the panel assembly, on which the ventilation performance is poor. Therefore, the electric and optical characteristics of the panel assembly can be improved greatly.

The etchant can be injected finely by controlling the width of the opening in the photoresist, thereby forming a barrier rib with uniform thickness.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A method of fabricating a plasma display panel, the method comprising:
patterning a photoresist over a raw material, wherein the raw material is disposed on a transparent substrate; and
injecting an etchant through openings of the photoresist to etch the raw material and form first barrier ribs in a first direction, and second barrier ribs in a second, different direction, wherein heights of the first and second barrier ribs are different from each other, thereby forming a gas exhaustion path for exhausting impure gas during a vacuum exhaustion process.

2. The method of claim 1, wherein the photoresist is patterned such that the second barrier ribs respectively connect pairs of adjacent first barrier ribs in alternate pairs to define discharge cells, and wherein a non-discharge region is formed between the first barrier ribs unconnected by the second barrier ribs, thereby providing an additional gas exhaustion path in the non-discharge region.

3. The method of claim 2, wherein a distance between the first barrier ribs that define a non-discharge region is narrower than a distance between the pair of first barrier ribs that define the discharge cell.

4. The method of claim 2, wherein a depth of the discharge cell is greater than a depth of the non-discharge region.

5. The method of claim 1, further comprising removing the photoresist remaining on the raw material to complete the barrier ribs including the first and second barrier ribs

6. The method of claim 1, further comprising preparing the transparent substrate prior to applying the raw material, wherein preparation of the transparent substrate comprises forming an address electrode on the transparent substrate, and applying a dielectric layer to cover the address electrode.

7. A plasma display panel comprising:
a front substrate;
a plurality of pairs of sustain discharge electrodes formed on an inner surface of the front substrate;
a front dielectric layer covering the sustain discharge electrode pairs;
a rear substrate facing the front substrate;
a plurality of address electrodes formed on an inner surface of the rear substrate and disposed in a direction crossing the sustain discharge electrode pairs;
a rear dielectric layer covering the address electrodes;
a plurality of barrier ribs including first barrier ribs that are disposed between the front and rear substrates and arranged in a first direction of the substrates, and second barrier ribs that extend from the first barrier ribs in a second, different direction to define discharge cells, wherein the second barrier ribs have different heights from those of the first barrier ribs, thereby providing a gas exhaustion path for exhausting impure gas during a vacuum exhaustion process; and
red, green, and blue phosphor layers applied in the discharge cells.

8. The plasma display panel of claim 7, wherein the height of the first barrier ribs is relatively lower than that of the second barrier ribs, and the gas exhaustion path corresponding to the height difference between the first and second barrier ribs is formed above the first barrier ribs.

9. The plasma display panel of claim 8, wherein the first barrier ribs are arranged in a direction crossing the address electrodes, the second barrier ribs are arranged in parallel to the address electrodes, and the second barrier ribs extend from the inner sides of the adjacent first barrier ribs toward the facing first barrier ribs to define the discharge cells.

10. The plasma display panel of claim 7, wherein a non-discharge region providing an additional gas exhaustion path for exhausting the impure gas is further formed between the pair of first barrier ribs defining the discharge cell with the second barrier ribs and the other pair of first barrier ribs adjacent to the above pair.

11. The plasma display panel of claim 10, wherein a distance between the first barrier ribs that define the non-discharge region is narrower than a distance between the pair of first barrier ribs that define the discharge cell.

12. The plasma display panel of claim 11, wherein a depth of the discharge cell is greater than a depth of the non-discharge region.

13. A plasma display panel with a gas exhaustion path fabricated by the method comprising:
applying a raw material for forming barrier ribs on a substrate;
patterning a photoresist on the raw material for forming first barrier ribs disposed in a first direction on the substrate and second barrier ribs disposed in a second direction, thereby defining discharge spaces;
etching the raw material through openings of the photoresist so that heights of the first and second barrier ribs are different from each other, thereby forming a gas exhaustion path for exhausting gas during a vacuum exhaustion process; and
removing the photoresist remaining on the raw material to complete the first and second barrier ribs.

14. The plasma display panel of claim 13, wherein the second barrier ribs respectively connect pairs of adjacent first barrier ribs in alternate pairs to define discharge cells, thereby providing an additional gas exhaustion path between the first barrier ribs that are not connected to each other.

15. The plasma display panel of claim 14, wherein a distance between the first barrier ribs that are not connected is narrower than a distance between the pair of first barrier ribs that define the discharge cell.

16. The plasma display panel of claim 13, further comprising forming a phosphor layer in each of the discharge spaces.

17. The plasma display panel of claim 13, wherein the first barrier ribs defining a discharge space have a length shorter than the second barrier ribs defining a discharge space.

18. The plasma display panel of claim 13, wherein patterning the photoresist comprises applying a photoresist over the raw material, applying a photolithographic mask over the photoresist, exposing the photolithographic mask and photoresist to ultraviolet light, and removing the photolithographic mask.

19. The plasma display panel of claim 13, wherein etching comprises the isotropic etching speed in both vertical and horizontal directions.

20. The plasma display panel of claim 13, wherein the photoresist patterning comprises providing different size openings for the first and second barrier ribs.
